(19) United States
(12) Patent Application Publication
(10) Pub. No.: US 2015/0113723 A1
(43) Pub. Date: Apr. 30, 2015

(54) SIDE SPRAYING SHOWER SYSTEM

(71) Applicants: Huasong Zhou, Xiamen (CN); XIAMEN SOLEX HIGH-TECH INDUSTRIES CO., LTD., Xiamen (CN)

(72) Inventors: Mingfu ZHANG, Xiamen (CN); Lei WANG, Xiamen (CN); Bin CAO, Xiamen (CN); Huasong ZHOU, Xiamen (CN)

(73) Assignees: XIAMEN SOLEX HIGH-TECH INDUSTRIES CO., LTD., Xiamen, Fujian (CN); Huasong ZHOU, Xiamen, Fujian (CN)

(21) Appl. No.: 14/149,123

(22) Filed: Jan. 7, 2014

(30) Foreign Application Priority Data
Oct. 25, 2013 (CN) 201310511998.7
Oct. 25, 2013 (CN) 201320666147.5

(51) Int. Cl. E03C 1/02; B05B 1/18

(52) U.S. Cl. CPC E03C 1/025; B05B 1/185
USPC 4/601

(57) ABSTRACT

A side spraying shower system includes a side spraying component and a hand shower. The side spraying component has a fixed portion secured to the wall and at least a side spraying mechanism. The fixed portion is disposed with an inlet waterway, a first waterway and a second waterway, the side spraying mechanism is able to connect to the first waterway, the inlet waterway is connected to a supporting arm by a first flexible pipe to lead the water to the inlet waterway, the hand shower is connected to the second waterway by a second flexible pipe. The fixed portion is further disposed with a switch mechanism which cooperates with the inlet waterway, the first waterway and the second waterway to switch the first waterway and the second waterway to connect to the inlet waterway, thus controlling the hand shower or the side spraying mechanism to discharge water.

### FIELD OF THE INVENTION

The present invention relates to a side spraying shower system.

### BACKGROUND OF THE INVENTION

Existing side spraying shower system, for example, disclosed is an outlet device in US patent database with publishing number U.S. Pat. No. 5,678,258 in Oct. 27, 1997. the outlet device comprising a side spraying shower, a head shower and a switch valve, the switch valve is fixed to the end of the supporting arm, the head shower is fixed to the switch valve and is connected to one diversion waterway of the switch valve, the side spraying shower is secured to the wall, and is fixed to the switch valve and is connected to another diversion waterway of the switch valve. water is controlled to flow out of the head shower or the side spraying shower by controlling the switch valve. the outlet device has disadvantages:1. the side spraying shower and the head shower are fixed to the supporting arm, the side spraying shower is fixed with respect to the wall, the supporting arm is fixed with respect to the side spraying shower, so that it has to ensure the position accurate when assembling, it costs much in assembly, and the assembly position is unable to adjust; 2. the switch valve is high in position, thus making it inconvenient to switch; 3. the head shower is single functional.

### SUMMARY OF THE INVENTION

The present invention is provided with a side spraying shower system, which overcomes the disadvantages of the outlet device of the existing technology.

The technical proposal of the present invention to solve the technical problems is as below:

A side spraying shower system, wherein comprising a side spraying component and a hand shower, the side spraying component comprising a fixed portion secured to the wall and at least a side spraying mechanism, the fixed portion is disposed with an inlet waterway, a first waterway and a second waterway, the side spraying mechanism is able to connect to the first waterway, the inlet waterway is connected to a supporting arm by a first flexible pipe to lead the water to the inlet waterway, the hand shower is connected to the second waterway by a second flexible pipe; the fixed portion is further disposed with a switch mechanism, the switch mechanism is cooperated to the inlet waterway, the first waterway and the second waterway to switch the first waterway and the second waterway to connect to the inlet waterway, thus controlling the hand shower or the side spraying mechanism to discharge water.

In another preferred embodiment, the fixed portion is disposed with a connecting base to hold the hand shower.

In another preferred embodiment, it comprising several side spraying mechanisms, the side spraying mechanisms are spaced arranged up and down.

In another preferred embodiment, the switch mechanism is disposed in the upper portion of the fixed portion, the connection of the second waterway and the second flexible pipe is placed in the lower portion of the fixed portion.

In another preferred embodiment, the fixed portion comprising a housing and a lower joint, the housing is able to secure to the wall, the second waterway comprising a third flexible pipe inside the housing, the lower joint is fixed to the lower end of the housing, the lower joint is connected to the third flexible pipe and the second flexible pipe.

In another preferred embodiment, the connecting base comprising a plug socket, the plug socket is secured to the fixed portion.

In another preferred embodiment, the switch mechanism comprising a switch valve fixed inside the fixed portion, a rotating base able to rotate with respect to the switch valve and at least a handle placed outside the fixed portion for the user to operate, the switch valve is disposed with a first water diversion opening and a second water diversion opening respectively connected to the first waterway and the second waterway, the inlet waterway is connected to the switch valve, the first water diversion opening and the second water diversion opening are controlled to alternately connect to the inlet waterway when the rotating base rotates.

In another preferred embodiment, the connecting base comprising a plug socket, the plug socket is secured to the fixed portion;

the switch mechanism comprising a switch valve fixed inside the fixed portion, a rotating base able to rotate with respect to the switch valve and at least a handle placed outside the fixed portion for the user to operate, the switch valve is disposed with a first water diversion opening and a second water diversion opening respectively connected to the first waterway and the second waterway, the inlet waterway is connected to the switch valve, the first water diversion opening and the second water diversion opening are controlled to alternately connect to the inlet waterway when the rotating base rotates;

the plug socket and the handle are respectively disposed at the two sides of the fixed portion at the upper portion of the fixed portion.

Compared to existing technology, the technical proposal of the present invention has advantages as below:

1. the side spraying component is connected to the supporting arm by flexible pipe, the side spraying component is not fixed to the support arm and the assembly portion thereof is adjustable, thus making it easy to assemble; the switch valve is disposed in the fixed portion of the side spraying component, the position is lower relatively, thus making it easy to switch.

2. The switch mechanism is fixed to the upper portion of the fixed portion, the connecting of the second waterway and the second flexible pipe is disposed in the lower portion of the fixed portion, thus making it with tight structure and reasonability.

3. the second waterway comprising a third flexible pipe inside the housing, the lower joint is fixed to the lower end of the housing, the lower joint is connected to the third flexible pipe and the second flexible pipe, thus making it simple structural and easy to assemble.

4. the plug socket and the handle are respectively disposed in the two sides of the fixed portion in the upper portion of the fixed portion, thus making it with tight structure.

### BRIEF DESCRIPTION OF THE DRAWINGS

The present invention will be further described with the drawings and the embodiments.

FIG. 1 illustrates a sectional view of the side spraying shower system.

FIG. 1-1 illustrates an enlargement view of the A portion of the FIG. 1.

FIG. 2 illustrates an exploded diagram of the side spraying shower system.

FIG. 3 illustrates a first side view of the side spraying shower system in first working state.

FIG. 4 illustrates a second side view of the side spraying shower system in first working state.

FIG. 5 illustrates a first side view of the side spraying shower system in second working state.

FIG. 6 illustrates a second side view of the side spraying shower system in second working state.

### DETAILED DESCRIPTION OF THE EMBODIMENTS

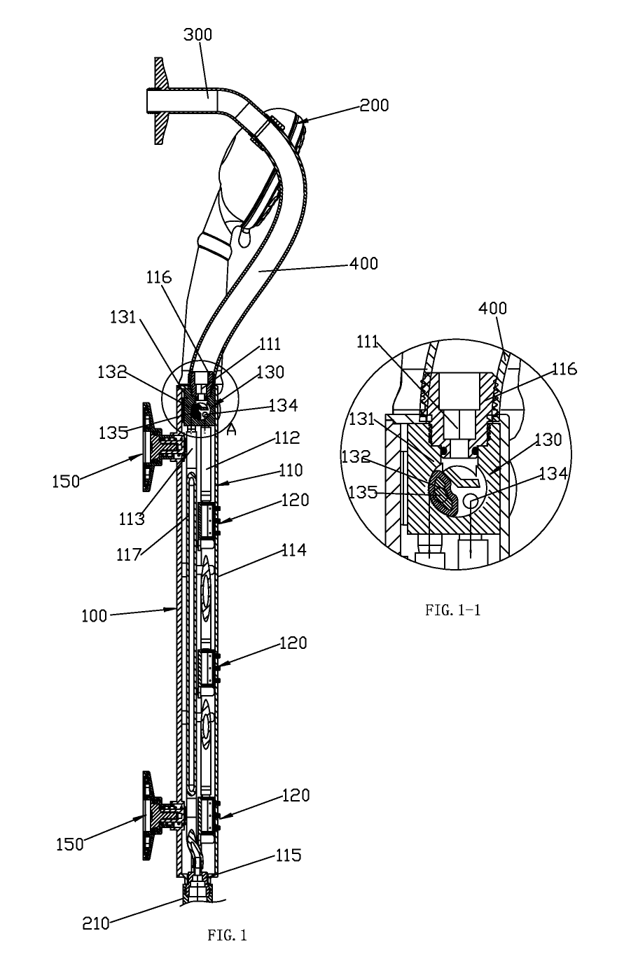

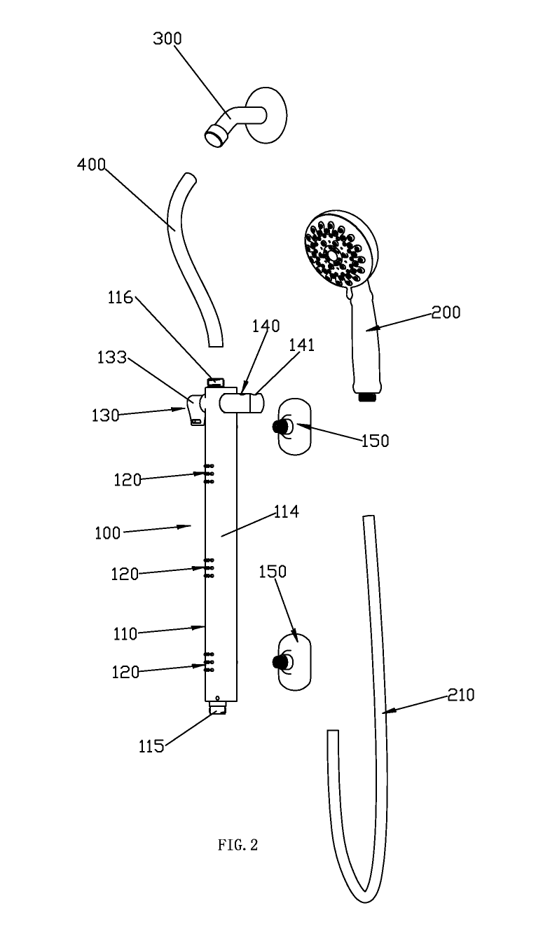

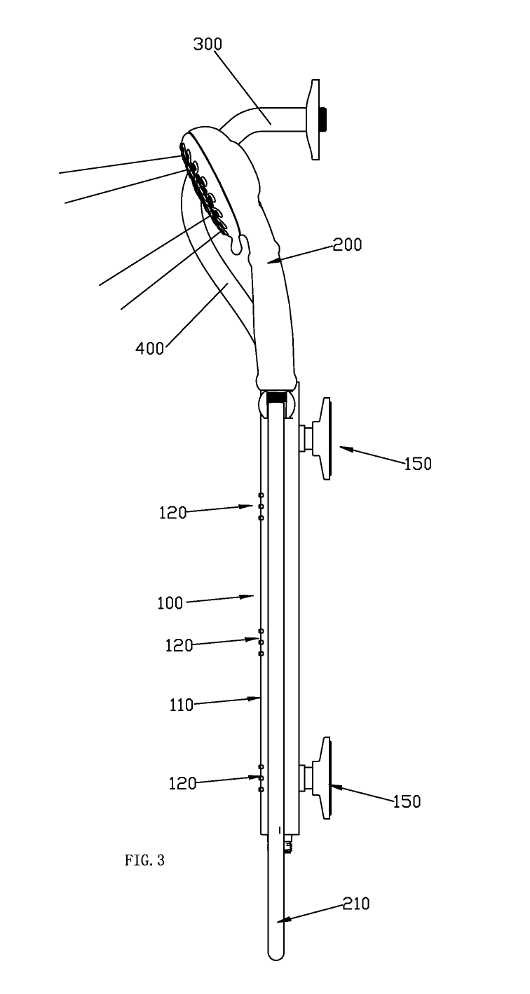

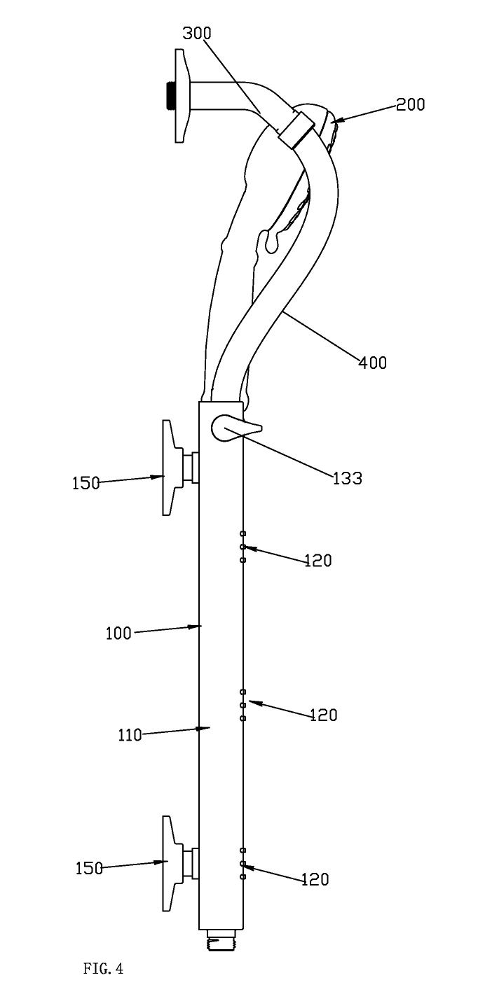

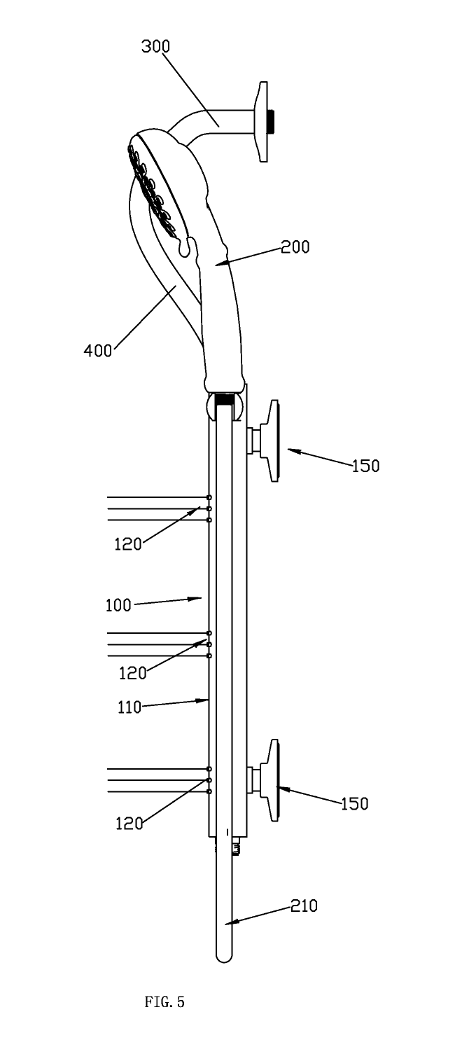

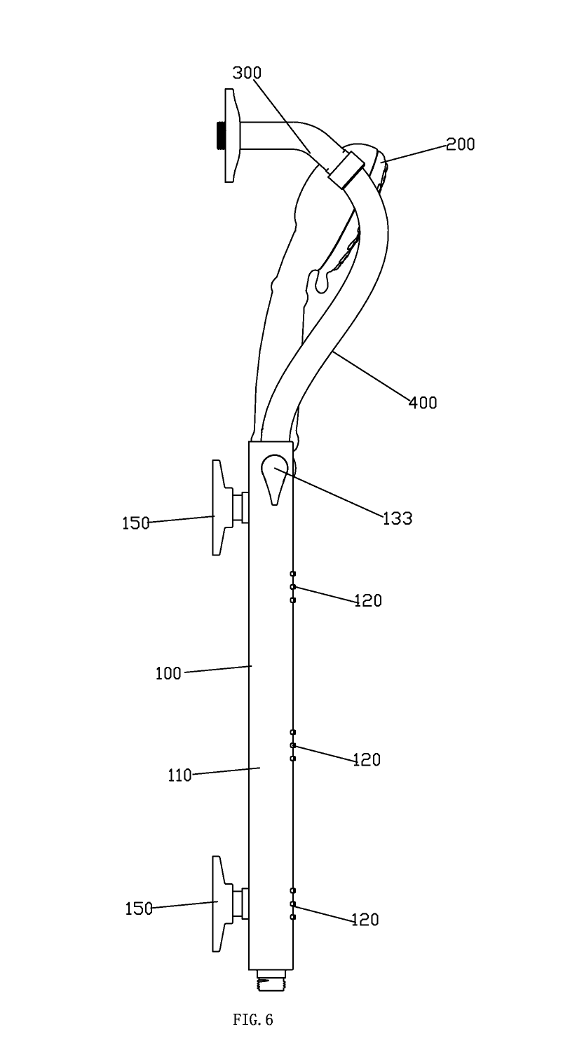

Please refer to FIG. 1 to FIG. 6, a side spraying shower system comprising a side spraying component 100 and a hand shower 200.

The side spraying component 100 comprising a fixed portion 110 secured to the wall and at least a side spraying mechanism 120, in this embodiment, it is disposed with three side spraying mechanisms 120, these three side spraying mechanisms 120 are spaced arranged up and down. The fixed portion 110 comprising an inlet waterway 111, a first waterway 112 and a second waterway 113, the inlet waterway 111 is connected to a supporting arm 300 by a first flexible pipe 400 to lead the water to the inlet waterway 111, the side spraying mechanism 120 are able to connect to the first waterway 112, the hand shower 200 is connected to the second waterway 113 by a second flexible pipe 210.

The fixed portion 110 is further disposed with a switch mechanism 130, which is cooperated to the inlet waterway 111, the first waterway 112 and the second waterway 113 to switch the first waterway 112 and the second waterway 113 to connect to the inlet waterway 111, thus controlling the hand shower 200 or the side spraying mechanisms 120 to discharge water. The fixed portion 110 is further disposed with a connecting base 140, which is used to hold the hand shower 200.

the fixed portion 110 comprising a housing 114, a lower joint 115 and an upper joint 116, the housing 114 is able secured to the wall, in this embodiment, the housing 114 is detachably secured to the wall by two sucker mechanisms 150, as needed, other securing assemblies are available, for example a securing assembly that can not be detached, for example screwing securing. The upper joint 116 is assembled to the upper end of the housing 114, the lower joint 115 is assembled to the lower end of the housing 114. the inlet waterway comprising the inner hole of the upper joint 116.

Preferred, the switch mechanism 130 is disposed in the upper portion of the fixed portion 110; the switch mechanism 130 comprising a switch valve 131 inside the housing 114, a rotating base 132 able to rotate with respect to the switch valve 131 and at least a handle 133 partially outside the housing 114 for the user to operate, the switch valve 131 is disposed with a first water diversion opening 134 and a second water diversion opening 135 respectively connected to the first waterway 112 and the second waterway 113, the inlet waterway 111 is connected to the switch valve 131, when controlling the rotating base 132 to rotate with respect to the switch valve 131 by the handle 133, the first water diversion opening and the second water diversion opening are controlled to alternately connect to the inlet waterway. In this embodiment, the switch mechanism is applied with a rotating switch mode, but not limited to this, as needed, sliding switch mode is available. As needed, a sealing pad is disposed in the switch valve, thus implementing accurate switch.

The second waterway 113 comprising a third flexible pipe 117 inside the housing, the lower joint 115 is fixed to the lower end of the housing 114, the lower joint 115 is connected to the third flexible pipe 117 and the second flexible pipe 210, so that the connection of the second waterway 113 and the second flexible pipe 117 is situated at the lower portion of the fixed portion. the first flexible pipe 400 is assembled to the upper joint 116 to lead water into the upper joint 116 and the to the switch valve 131.

The connecting base 140 comprising a plug socket 141, which is fixed to the upper portion of the housing 114, preferred, the plug socket 141 and the handle 133 are respectively disposed in the left and the right sides of the housing 114.

Although the present invention has been described with reference to the preferred embodiments thereof for carrying out the patent for invention, it is apparent to those skilled in the art that a variety of modifications and changes may be made without departing from the scope of the patent for invention which is intended to be defined by the appended claims.

1. A side spraying shower system, wherein comprising a side spraying component and a hand shower, the side spraying component comprising a fixed portion secured to the wall and at least a side spraying mechanism, the fixed portion is disposed with an inlet waterway, a first waterway and a second waterway, the side spraying mechanism is able to connect to the first waterway, the inlet waterway is connected to a supporting arm by a first flexible pipe to lead the water to the inlet waterway, the hand shower is connected to the second waterway by a second flexible pipe; the fixed portion is further disposed with a switch mechanism, the switch mechanism is cooperated to the inlet waterway, the first waterway and the second waterway to switch the first waterway and the second waterway to connect to the inlet waterway, thus controlling the hand shower or the side spraying mechanism to discharge water.

2. The side spraying shower system according to claim 1, wherein the fixed portion is disposed with a connecting base to hold the hand shower.

3. The side spraying shower system according to claim 1, wherein comprising several side spraying mechanisms, the side spraying mechanisms are spaced arranged up and down.

4. The side spraying shower system according to claim 1, wherein the switch mechanism is disposed in the upper portion of the fixed portion, the connection of the second waterway and the second flexible pipe is placed in the lower portion of the fixed portion.

5. The side spraying shower system according to claim 1, wherein the fixed portion comprising a housing and a lower joint, the housing is able to secure to the wall, the second waterway comprising a third flexible pipe inside the housing, the lower joint is fixed to the lower end of the housing, the lower joint is connected to the third flexible pipe and the second flexible pipe.

6. The side spraying shower system according to claim 2, wherein the connecting base comprising a plug socket, the plug socket is secured to the fixed portion.

7. The side spraying shower system according to claim 1, wherein the switch mechanism comprising a switch valve fixed inside the fixed portion, a rotating base able to rotate with respect to the switch valve and at least a handle placed outside the fixed portion for the user to operate, the switch valve is disposed with a first water diversion opening and a second water diversion opening respectively connected to the first waterway and the second waterway, the inlet waterway is connected to the switch valve, the first water diversion opening and the second water diversion opening are controlled to alternately connect to the inlet waterway when the rotating base rotates.

8. The side spraying shower system according to claim 2, wherein:
the connecting base comprising a plug socket, the plug socket is secured to the fixed portion;
the switch mechanism comprising a switch valve fixed inside the fixed portion, a rotating base able to rotate with respect to the switch valve and at least a handle placed outside the fixed portion for the user to operate, the switch valve is disposed with a first water diversion opening and a second water diversion opening respectively connected to the first waterway and the second waterway, the inlet waterway is connected to the switch valve, the first water diversion opening and the second water diversion opening are controlled to alternately connect to the inlet waterway when the rotating base rotates;
the plug socket and the handle are respectively disposed at the two sides of the fixed portion at the upper portion of the fixed portion.

9. The side spraying shower system according to claim 2, wherein the switch mechanism comprising a switch valve fixed inside the fixed portion, a rotating base able to rotate with respect to the switch valve and at least a handle placed outside the fixed portion for the user to operate, the switch valve is disposed with a first water diversion opening and a second water diversion opening respectively connected to the first waterway and the second waterway, the inlet waterway is connected to the switch valve, the first water diversion opening and the second water diversion opening are controlled to alternately connect to the inlet waterway when the rotating base rotates.

10. The side spraying shower system according to claim 3, wherein the switch mechanism comprising a switch valve fixed inside the fixed portion, a rotating base able to rotate with respect to the switch valve and at least a handle placed outside the fixed portion for the user to operate, the switch valve is disposed with a first water diversion opening and a second water diversion opening respectively connected to the first waterway and the second waterway, the inlet waterway is connected to the switch valve, the first water diversion opening and the second water diversion opening are controlled to alternately connect to the inlet waterway when the rotating base rotates.

11. The side spraying shower system according to claim 4, wherein the switch mechanism comprising a switch valve fixed inside the fixed portion, a rotating base able to rotate with respect to the switch valve and at least a handle placed outside the fixed portion for the user to operate, the switch valve is disposed with a first water diversion opening and a second water diversion opening respectively connected to the first waterway and the second waterway, the inlet waterway is connected to the switch valve, the first water diversion opening and the second water diversion opening are controlled to alternately connect to the inlet waterway when the rotating base rotates.

12. The side spraying shower system according to claim 5, wherein the switch mechanism comprising a switch valve fixed inside the fixed portion, a rotating base able to rotate with respect to the switch valve and at least a handle placed outside the fixed portion for the user to operate, the switch valve is disposed with a first water diversion opening and a second water diversion opening respectively connected to the first waterway and the second waterway, the inlet waterway is connected to the switch valve, the first water diversion opening and the second water diversion opening are controlled to alternately connect to the inlet waterway when the rotating base rotates.

13. The side spraying shower system according to claim 6, wherein the switch mechanism comprising a switch valve fixed inside the fixed portion, a rotating base able to rotate with respect to the switch valve and at least a handle placed outside the fixed portion for the user to operate, the switch valve is disposed with a first water diversion opening and a second water diversion opening respectively connected to the first waterway and the second waterway, the inlet waterway is connected to the switch valve, the first water diversion opening and the second water diversion opening are controlled to alternately connect to the inlet waterway when the rotating base rotates.
